(19) United States
(12) Patent Application Publication
(10) Pub. No.: US 2010/0186845 A1
(43) Pub. Date: Jul. 29, 2010

(54) HOSE DEVICE

(76) Inventor: Inge Knotten, Trondheim (NO)

Correspondence Address: DENNISON, SCHULTZ & MACDONALD, 1727 KING STREET, SUITE 105, ALEXANDRIA, VA, 22314, US

(21) Appl. No.: 12/664,931

(22) PCT Filed: May 27, 2008
(86) PCT No.: PCT/NO2008/000185

§ 371 Date: Feb. 2, 2010

(30) Foreign Application Priority Data
Jul. 6, 2007 (NO) 20073470

(51) Int. Cl. F16L 11/00

(52) U.S. Cl. 138/104; 138/109; 138/114; 138/148; 285/97; 285/123.1

(57) ABSTRACT

Device for a hose structure (11) with an inner main hose (12) and an outer cover hose (13) which delimits a pipe-shaped air filled space (14) intended to give the hose uplift in water. At one end there is a coupling element (15) which forms a fastening for the main hose and cover hose and which at its free end is connected to or integrated with a coupling part (16) for connection of the hose structure (11) to an outer connection. The coupling element (15) comprises an inner sleeve in which the end (18) of the main hose (12) is inserted into and fixed to. An internal sleeve (22) is associated with the coupling part (16), as the inner sleeve (17) has outside threads (20). It comprises an outer sleeve (24) with the end of the cover hose clamped to it and with inside threads for screwing onto the inner sleeve (17).

The invention relates to a hose device of the type as described in the introductory part of claim 1. Specifically the invention relates to a hose structure with an inner main hose and an outer cover hose which delimit a pipe shaped space with air intended for giving the hose uplift in water. Close to one end there is a coupling element which forms a fastening for the main hose and the cover hose and which at is free end is connected or integrated with a coupling part for connection of the hose structure to an outer connection.

### BACKGROUND

For offshore transmission of media which may be pumped, for example for refuelling of platforms from supply boats or transmission of mud from one platform to a supply boat, hoses which can float on the water are used. For this purpose floating bodies are fastened to ordinary hoses or pipe shaped casings of foam material are fastened to the hoses. Both of these hose structures provide uplift, but are not safe. In addition known structures are not durable.

Nowadays there is an increased emphasise on problems associated with pollution by emission, also there is a need for safety measures in addition to the up dimensioning of the hoses.

Double hoses are known where the outer hose collects leaks from the inner hose. Such safety hoses are designed so that they float in water. However a satisfactory floating hose that is safe is not known. For example U.S. Pat. No. 6,085,796 (Riga, 2000) discloses a composite safety hose with an inner and one outer hose, which is intended for hydraulic systems. It has a low transport capacity. The design of the end couplings has not proved satisfactory.

Also known are double pipes with a foam material in the outer ring space, to form thermal isolation. Such a structure is known from U.S. Pat. No. 6,349,976 (Mentor Subsea, 2002), but this is not suitable as floating hose.

### PURPOSE

The main purpose of the invention is to create a floating hose which is prepared for rational production and which has good utilisation potential. In addition it should be able to monitor leakage of the contents in the hose and preferably be able to collect the content from a starting leakage.

Another purpose is to create such a composite hose that makes changing of leaking hose parts simpler and cheaper.

Further purposes will appear from the following example description.

### THE INVENTION

The invention is depicted in claim 1 and the following claims 2-5.

More specific the coupling element comprises
An inner sleeve into which the end of the main hose is inserted and fixed to
An internal sleeve in connection with the coupling element, as the inner sleeve has outside threads and
An outer sleeve with one end of the cover hose fixed and with inside threads for screwing the inner sleeve into it.

The hose structure may comprise a channel which connects the air space between the main hose and the cover hose with an outside coupling element for a pressure sensor.

This channel extends through the outer part of the inner sleeve.

The internal sleeve is preferably expanded by a die element which has been drawn through.

The internal sleeve has preferably a cone interface against the outer sleeve.

Further details regarding the invention will appear from the example description.

### EXAMPLE

The invention is illustrated in the drawings where

FIG. 1 shows a picture in perspective of one end of a composite hose designed in accordance with the invention,

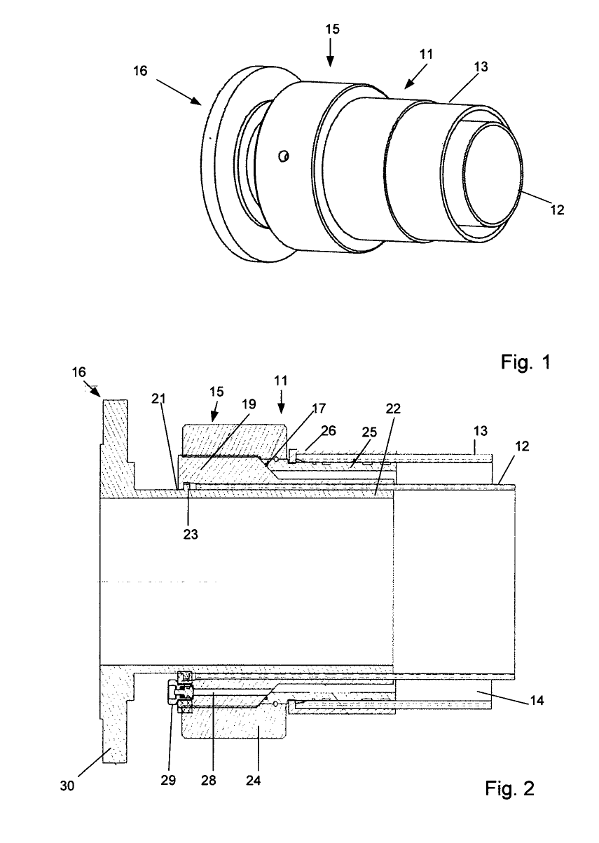

FIG. 2 shows an axial intersection through the end of the composite hose in FIG. 1, while

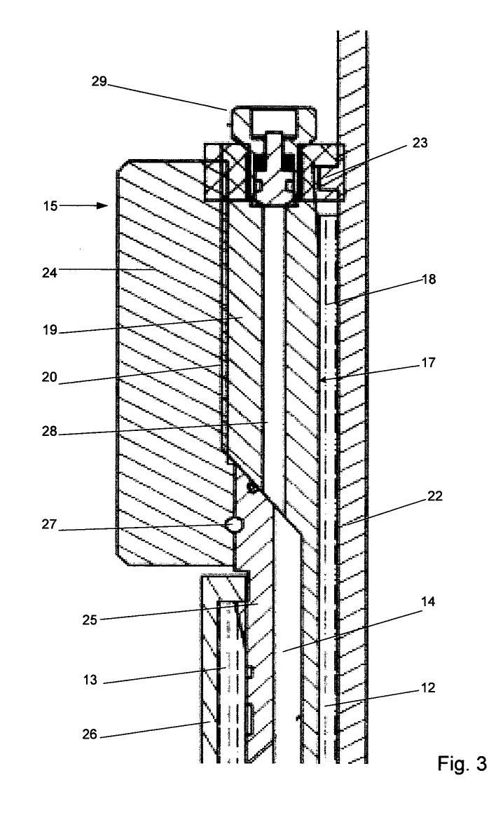

FIG. 3 shows an enlarged section of the coupling element for the main hose and the outer hose in FIG. 2.

FIG. 1 shows a composite or compound hose 11 designed in accordance with the invention. The main element is an inner main hose 12 which may be used for transmission of bunker oil, mud or other masses which can be pumped between two units which is separated by water so that the hose must be placed on the water surface.

The main hose 12 is surrounded by a cover hose 13 which may have a diameter which forms a pipe-shaped intermediate space 14 between the two hoses. The intermediate space 14 will be filled with air in order to reduce the weight of the composite hose, so that it keeps floating on the water. But it may also be filled with another gas or completely or partly filled with a foam material. To keep a distance between the main hose 11 and the cover hose 12, it may by an alternative embodiment be arranged spacers, for example in the form of a pipe-shaped corrugated profile in the intermediate space 14.

To connect the main hose 11 and the cover hose 12 there is at each end or by extension parts, a coupling element 15 which in this case is composed as described below.

In the example in the Figures the coupling element 15 is connected with an end coupling 16 which is also described below. In connection with a joint part the coupling element 15 will be arranged in tandem in a known manner.

The coupling element 15 comprises a coupling sleeve 17 which encloses the end 18 of the main hose and which by its free end has an extension 19 with outside threads 20 and with an end flange 21 radially inwards directed. The main hose 12 is fixed to the coupling sleeve 17 by a sleeve shaped part 22 of the end coupling 16, which is pressed into contact against the inner wall of the main hose 12.

To ensure that the end coupling 16 is not drawn out from the coupling sleeve 17, there is provided an integrated radial ring edging 23 which interfaces the inner side of the end flange 21.

The coupling element 15 further comprises an outer cover sleeve with inside threads that correspond to the threads 20 outside at the extension 19 of the inner coupling sleeve 17. The cover sleeve 24 is connected with a pipe socket 25 which is inserted into the end of the cover hose 13 and locked to this with an outside collar 26 that is crimped on. The pipe socket 25 is inserted in the cover sleeve 24 and locked to this with an O-ring 27 lying in a couple of grooves.

Axially through the extension 19 a channel 28 extends where at the outer end is placed an adapter 29 for connection of a pressure sensor. In this way the composite hose 11 may be connected to a pressure monitoring system which can alert leakage with an increase of the pressure in the intermediate space 14.

The sleeve shaped part 22 of the coupling element 16 is integrated with an outer flange 30 which may be fastened to a coupling part at a boat or a platform. Alternatively it may be made with another coupling part, for example with outside threads, for example for connection to a swivel.

The sleeve shaped part or sleeve 22 is expanded by drawing a die element or drift through. The inner sleeve 17 has a cone interface against the outer sleeve 24.

The invention is primarily suited for creating a floating hose which may be used for different offshore purposes. The invention has better safety qualities and use, than known hoses for similar purposes. The composite hose is useful in relation to safety, both to register leakage in a main hose and to collect such a leakage.

1. Hose structure device (11) with an inner main hose (12) and an outer cover hose (13) which delimits a pipe-shaped space of air (14) intended to give the hose uplift in water, and where, at each end, there is a coupling element (15) which forms a fastening for the main hose and cover hose and which at its free end is connected to or integrated with a coupling part (16) for connection of the hose structure (11) to an outer connection, characterized in that the coupling element (15) comprises
an inner sleeve (17) in which the end (18) of the main hose (12) is inserted into and fixed to
an internal sleeve (22) associated to the coupling part (16), as the inner sleeve (17) has outside threads (20) and
an outer sleeve (24) with one end of the cover hose (13) fixed to it and with inside threads for screwing on to the inner sleeve (17).

2. Hose structure device according to claim 1, characterized in that it comprises a channel (28) which connects the air filled space (14) between the main hose (12) and the cover hose (13) with an outside coupling element (29) for a pressure sensor.

3. Device according to claim 2, characterized in that the channel (28) extends through the outer part (19) of the inner sleeve (17).

4. Device according to claim 1, characterized in that the internal sleeve (22) is expanded by drawing a die element through.

5. Device according to claim 1, characterized in that the inner sleeve (17) has a cone interface against the outer sleeve (24).
